(19) United States
(12) Patent Application Publication
(10) Pub. No.: US 2025/0118513 A1
(43) Pub. Date: Apr. 10, 2025

(54) TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 18/904,149

(22) Filed: Oct. 2, 2024

(30) Foreign Application Priority Data
Oct. 10, 2023 (DE) 10 2023 127 597.6

(51) Int. Cl. H01H 37/54

(52) U.S. Cl. CPC H01H 37/5427

(57) ABSTRACT

A temperature-dependent switch comprising a switch housing, a contact carrier element, and a temperature-dependent switching mechanism. The switch housing has a lower part and a cover part closing the lower part. The contact carrier element is arranged in the switch housing and comprises a contact surface, wherein at least a section of the contact carrier element is fixed in position by an interaction of the lower part and the cover part. The temperature-dependent switching mechanism is arranged in the switch housing and comprises a movable contact part which interacts with the contact surface arranged at the contact carrier element. The switching mechanism is configured to switch in a temperature- dependent manner between a low-temperature state, in which it establishes an electrical connection between first and second electrical terminals of the switch, and a high- temperature state, in which it interrupts the electrical connection between the first and second electrical terminals.

### CROSS-REFERENCE TO RELATED APPLICATIONS

This application claims priority from German patent application DE 10 2023 127 597.6 filed on Oct. 10, 2023. The entire contents of this priority application are incorporated herein by reference.

### FIELD

This disclosure relates to a temperature-dependent switch.

Exemplary temperature-dependent switches are disclosed in DE 10 2018100 890 B3, DE 10 2009 030 353 B3, DE 197 27 383 A1 and DE 197 27 197 A1 .

Such temperature-dependent switches are used in a principally known manner to monitor the temperature of a device. For this purpose, the switch is brought into thermal contact with the device to be protected, e.g. via one of its outer surfaces, so that the temperature of the device to be protected influences the temperature of the switching mechanism arranged inside the switch.

The switch is typically connected electrically in series into the supply circuit of the device to be protected via connecting cables, so that below the response temperature of the switch, the supply current of the device to be protected flows through the switch.

In the switch disclosed in DE 10 2018 100 890 B3, the switching mechanism is arranged inside a switch housing. The switch housing is a closed housing in which the switching mechanism is sealed against the outside. The switch housing is formed in two parts. It comprises a lower part which is closed by a cover part. The cover part is fixed to the lower part. For this purpose, the lower part comprises a raised, circumferential edge, the free, upper edge of which is bent or flanged onto the cover part.

The temperature-dependent switching mechanism arranged in the switch housing comprises a spring element, to which a movable contact part is fixed, and a bimetal element that interacts with the movable contact part. The spring element presses the movable contact part against a stationary counter contact arranged on the inside of the switch housing on the cover part. The outer edge of the spring element, which is configured as a snap-action spring disc, is supported in the lower part of the switch housing so that the electric current flows from the lower part through the snap-action spring disc and the movable contact part into the stationary counter contact and from there into the cover part.

The temperature-dependent bimetal element, which is in the switch disclosed in DE 10 2018 100 890 B3 has a disc-shaped design and is often referred to as a bimetal snap-action disc, is essentially responsible for the temperature-dependent switching behavior of the switching mechanism. This bimetal element is usually configured as a multi-layer, active, sheet-shaped device composed of two, three or four interconnected components with different thermal expansion coefficients. The connection of the individual metal or metal alloy layers in bimetal elements of this type is usually a material-locking or positive locking and is achieved, for example, by rolling.

Such a bimetal element has a first stable geometric configuration (low-temperature configuration) at low temperatures, below the response temperature of the bimetal element, and a second stable geometric configuration (high-temperature configuration) at high temperatures, above the response temperature of the bimetal element. The bimetal element snaps from its low-temperature configuration to its high-temperature configuration in a temperature-dependent manner in the manner of a hysteresis.

Thus, if the temperature of the bimetal element rises above the response temperature of the bimetal element as a result of a temperature increase in the device to be protected, the bimetal element snaps from its low-temperature configuration to its high-temperature configuration. Thereby, the bimetal element works against the spring element in such a way that it lifts the movable contact part from the stationary counter contact, so that the switch opens and the device to be protected is switched off and cannot heat up any further.

Unless a reset lock is provided, the bimetal element snaps back to its low-temperature configuration so that the switch is closed again as soon as the temperature of the bimetal element drops below the so-called reset temperature of the bimetal element as a result of cooling of the device to be protected.

In its low-temperature configuration, the bimetal element is preferably mounted in the switch housing in a mechanically force-free manner, wherein the bimetal element is also not used to carry the current. This has the advantage that the bimetal element has a longer service life and that the switching point, i.e. the response or switching temperature of the bimetal element, does not change even after many switching cycles.

In order for such temperature-dependent switches to function properly, it is of immense importance that the individual components of the temperature-dependent switching mechanism and the switch housing are very precisely matched to each other. In particular, it is important in this respect that the level of the interior of the switch housing is very precisely matched to the level of the switching mechanism in the low-temperature state so that, for example, the contact pressure between the moving contact part and the stationary counter contact is set correctly. This also has an influence on the contact resistances that arise at the transitions between the individual components of the switching mechanism and thus also on the performance of the switch.

For these reasons, the individual components of such a temperature-dependent switch must be manufactured with very tight tolerances and must be dimensionally very precisely matched to each other. Accordingly, very precise preliminary checks of the individual switch components are necessary. In some cases, it is also necessary to manually rework individual components or, depending on the manufacturing tolerances, to manually select suitable pairs of components in order to comply with the overall tolerances. This makes automated assembly of such temperature-dependent switches more difficult.

In the switch disclosed in DE 10 2018 100 890 B3, the level of the interior space of the switch housing is determined in particular by using a spacer ring, which is arranged inside the switch housing between the lower part and the cover part and keeps these two parts at a distance. By using spacer rings of different heights, the level of the interior of the housing and thus the contact pressure can be adjusted correspondingly according to customer requirements. This can also be used to compensate for the manufacturing tolerances of the switching mechanism components. However, the level of the spacer ring must then usually be manually adjusted to the manufacturing tolerances of the switching mechanism components.

There is therefore still room for further improvements. In particular, the manufacturability of the switch can be improved, its assembly simplified and a higher degree of automation achieved.

### SUMMARY

It is an object to provide a temperature-dependent switch in which, in particular, the points mentioned above are further improved. In particular, this is intended to simplify the assembly process and enable variable adaptation to certain customer requirements, for example with regard to the setting of contact resistances between the switching mechanism components.

According to an aspect, a temperature-dependent switch is presented, comprising:
switch housing having a lower part and a cover part closing the lower part;
a contact carrier element arranged in the switch housing and comprising a contact surface, wherein at least a section of the contact carrier element is fixed in position by an interaction of the lower part and the cover part; and
a temperature-dependent switching mechanism, which is arranged in the switch housing and comprises a movable contact part which interacts with the contact surface arranged at the contact carrier element, wherein the switching mechanism is configured to switch in a temperature-dependent manner between a low-temperature state, in which it presses the movable contact part against the contact surface and thus establishes an electrical connection between a first electrical terminal of the switch and a second electrical terminal of the switch, and a high-temperature state in which it keeps the movable contact part spaced apart from the contact surface and thus interrupts the electrical connection between the first electrical terminal and the second electrical terminal.

In the switch, the stationary contact surface (referred to here as the “contact surface”), which interacts with the movable contact part in the low-temperature state of the switching mechanism, is not arranged at the cover part, unlike in most switches known to date, but on an extra contact carrier element, which is arranged in the switch housing and is fixed in position by an interaction of the lower part and the cover part.

“Fixed in position by an interaction of the lower part and the cover part” means that the contact carrier element is fixed in position by the interaction of the two switch housing components (cover part and lower part). The contact carrier element is therefore only fixed in position when the two switch housing components are connected to each other. The two switch housing components only then together exert a force on the contact carrier element, fixing it in its position.

The extra contact carrier element has various advantages. On the one hand, the mechanical stability of the switch structure is improved by the provision of an additional contact carrier element. On the other hand, the contact pressure with which the movable contact part is pressed against the contact surface in the low-temperature state of the switching mechanism can be very easily determined or adjusted by a correspondingly adjustable shaping of the contact carrier element. In particular, it is advantageous that this type of contact pressure adjustment can be made almost independently of the shape of the lower part and cover part of the switch housing. By selecting differently shaped contact carrier elements, it is possible, for example, to realize different contact pressures and thereby also different contact resistances in one and the same switch housing, depending on customer requirements, without having to change the shape of the lower part and cover part of the switch housing.

The contact carrier element also makes it relatively easy to compensate for manufacturing tolerances on the switching mechanism components, for example by adapting the shape of the contact carrier element or making it elastic or resilient. The preliminary checks mentioned at the beginning regarding the manufacturing tolerances of the individual housing components or switching mechanism components can thus be omitted or at least reduced to a minimum.

Furthermore, the provision of the contact carrier element also has the additional advantage that one or both external terminals can be welded to the cover part, which is otherwise not possible or only possible with difficulty, as the stationary counter contact has usually become detached from the cover part due to the heat generated thereby. However, as the contact surface is now arranged at the contact carrier element rather than at the cover part, this problem is also solved at the same time.

The switch can be manufactured both manually and fully automatically. Fully automatic production is also simplified by the contact carrier element for the reasons mentioned above.

In a refinement, the switching mechanism is either (i) arranged between the contact carrier element and the lower part and the contact carrier element is connected to the cover part in an electrically conductive manner, or (ii) the switching mechanism is arranged between the contact carrier element and the cover part and the contact carrier element is connected to the lower part in an electrically conductive manner.

In other words, the switching mechanism is arranged between one of the two housing components (cover part or lower part) and the contact carrier element. The contact carrier element thus acts as a kind of additional cover or additional lower part that interacts with the switching mechanism.

If the switching mechanism is arranged according to alternative (i) between the contact carrier element and the lower part, the electrically conductive connection between the contact carrier element and the cover part is preferably realized by the contact carrier element resting against the cover part. If, on the other hand, the switching mechanism is arranged according to alternative (ii) between the contact carrier element and the cover part, the electrically conductive connection between the contact carrier element and the lower part is preferably realized by the contact carrier element resting against the lower part.

Viewed the other way around, the contact carrier element is arranged between the switching mechanism and the cover part according to alternative (i) and between the switching mechanism and the lower part according to alternative (ii).

In a further refinement, the at least one section of the contact carrier element, which is fixed in position by the interaction of the lower part and the cover part, comprises an outer edge of the contact carrier element and a central area of the contact carrier element is spaced from both the lower part and the cover part.

In other words, the contact carrier element is preferably fixed in its position on the edge side by the interaction of the lower part and the cover part. Particularly preferably, the at least one section of the contact carrier element comprises a radially outer edge of the contact carrier element. This has the advantage that the edge side of the contact carrier element is mounted in the most space-saving manner possible, while the central area of the contact carrier element is freely accessible for the switching mechanism and can be shaped relatively freely corresponding to the desired customer specification with regard to contact pressure and contact resistance. Due to the fact that the central area of the contact carrier element is spaced from both the lower part and the cover part, this central area is flexible or resilient, which ensures optimum tolerance compensation.

In a further refinement, the contact carrier element, in particular an outer edge of the contact carrier element, is clamped directly or indirectly between the lower part and the cover part.

Such a clamping arrangement between the lower part and the cover part is a particularly easy way of fixing the position of the contact carrier element. The contact carrier element can thus be easily inserted into the interior of the switch housing at the desired position during assembly of the switch, so that the switch housing can then be closed by fixing the cover part to the lower part or vice versa. No additional effort is required in the assembly process by the contact carrier element. On the contrary, this assembly effort can be reduced due to the aforementioned advantages that the contact carrier element brings with it.

With “indirectly clamped” is meant in the present case that the contact carrier element is clamped together by the cover part and the lower part, but it does not necessarily have to be in direct contact with these two switch housing components. Furthermore, housing components or elements can be arranged in between.

In a refinement, the temperature-dependent switching mechanism comprises a first spring element interacting with the movable contact part and a bimetal element interacting with the movable contact part.

The first spring element is preferably configured as a temperature-independent circular disc-shaped spring disc. The bimetal element is preferably configured as a temperature-dependent circular disc-shaped bimetal disc. The contact carrier element is also preferably circular in a plan view from above.

In a refinement, the contact carrier element is configured in a lid-like manner and has a thinner wall thickness than the cover part.

According to this refinement, the contact carrier element thus acts as a kind of sub cover, which is arranged inside the switch housing between the cover part and the lower part and on which the (stationary) contact surface is arranged. The thinner wall thickness compared to the cover part has the advantage that the contact carrier element can be configured to be much more flexible or elastic than the cover part. In other words, the cover part still serves as the main protection and mechanical stability carrier, while the contact carrier element can be relatively thin-walled in order to be variably adaptable to the shape of the switching mechanism.

In a further refinement, the switching mechanism comprises the above-mentioned first spring element which, in the low-temperature state of the switching mechanism, exerts a first spring force by which the movable contact part is pressed against the contact surface.

This first spring element is preferably a snap-action spring disc, as is usually inserted in switching mechanisms of such temperature-dependent switches. The first spring element is in the low-temperature state of the switching mechanism preferably used as a current-carrying component.

In a further refinement, the contact carrier element comprises a second spring element which, in the low-temperature state of the switching mechanism, exerts a second spring force by which the contact surface is pressed against the movable contact part.

The first spring force exerted by the first spring element is preferably opposite to the second spring force exerted by the second spring element.

According to this refinement, the contact carrier element can comprise the second spring element or be formed entirely by it. In other words, the contact carrier element can also be configured as a (second) spring element in its entirety. Irrespective of whether the contact carrier element comprises the second spring element or is formed entirely by it, such a resilient configuration of the contact carrier element has the advantage that the contact pressure with which the movable contact part is pressed against the contact surface in the low-temperature state of the switching mechanism can be significantly increased as a result.

In contrast to conventional temperature-dependent switches, two counteracting springs are used in the switch according to this configuration, both of which ensure that the movable contact part is pressed against the contact surface arranged at the contact carrier element in the low-temperature state of the switch. By this increased contact pressure, the contact resistance between the movable contact part and the contact surface can be reduced, thereby increasing the performance of the switch.

The suspension or resilient configuration of the contact carrier element also improves the already mentioned mechanical tolerance compensation, which is achieved by the contact carrier element.

The second spring force exerted by the second spring element in the contact carrier element is preferably larger in amount than the first spring force exerted by the first spring element belonging to the switching mechanism.

This has the advantage that the contact pressure is mainly caused by the second spring element. This in turn is advantageous in particular in that the opening force required to open the switching mechanism, i.e. to move the switching mechanism from its low-temperature state to its high-temperature state, can be lower than usual. In order to open the switching mechanism, the first spring force caused by the first spring element must be overcome. This is typically done by a bimetal element belonging to the switching mechanism.

As far as the spring travel is concerned, the first spring element preferably has a larger spring travel than the second spring element.

This has the advantage that the second spring element does not yield too much and does not follow the movement of the movable contact part when the switching mechanism opens, i.e. when shifting from the low-temperature state to the high-temperature state. Thus, despite the two spring elements working against each other, an effective opening of the switching mechanism can be achieved upon reaching the response temperature.

Preferably, in the high-temperature state of the switching mechanism, the bimetal element exerts an opening force on the movable contact part which is opposite to the first spring force and is larger in amount than the first spring force.

Upon reaching the response temperature, the bimetal element thus snaps into its high-temperature configuration and thereby lifts off the movable contact part from the contact surface, which is arranged at the contact carrier element, against the spring force exerted by the first spring element.

In a further refinement, the first electrical terminal of the switch is arranged on an outside of the cover part and the second electrical terminal of the switch is arranged on an outside of the lower part.

This ensures that the temperature-dependent switch is easy to connect electrically.

In a further refinement, the switch further comprises an insulating foil arranged between the lower part and the contact carrier element.

The contact carrier element is thus effectively electrically insulated from the lower part.

Preferably, the contact carrier element and the lower part are each made of an electrically conductive material.

In a further refinement, the lower part comprises a free, upper edge that is flanged or bent onto the cover part.

This results in the simplest and most stable type of fixation possible between the lower part and the cover part, as is known, for example, from DE 10 2018 100 890 B3.

It is to be understood that the features mentioned above and those to be explained below can be used not only in the combination indicated in each case, but also in other combinations or on their own, without departing from the spirit and scope of the present disclosure.

### BRIEF DESCRIPTION OF THE DRAWINGS

FIG. 1 shows a schematic sectional view of the temperature-dependent switch according to a first embodiment, wherein the switch is in its low-temperature state.

FIG. 2 shows a schematic sectional view of the temperature-dependent switch shown in FIG. 1, wherein the switch is in its high-temperature state.

FIG. 3 shows a schematic sectional view of the temperature-dependent switch according to a second embodiment, wherein the switch is in its low-temperature state.

FIG. 4 shows a schematic sectional view of the temperature-dependent switch according to a third embodiment, wherein the switch is in its low-temperature state.

FIG. 5 shows a schematic sectional view of the temperature-dependent switch according to a fourth embodiment, wherein the switch is in its low-temperature state.

### DESCRIPTION OF PREFERRED EMBODIMENTS

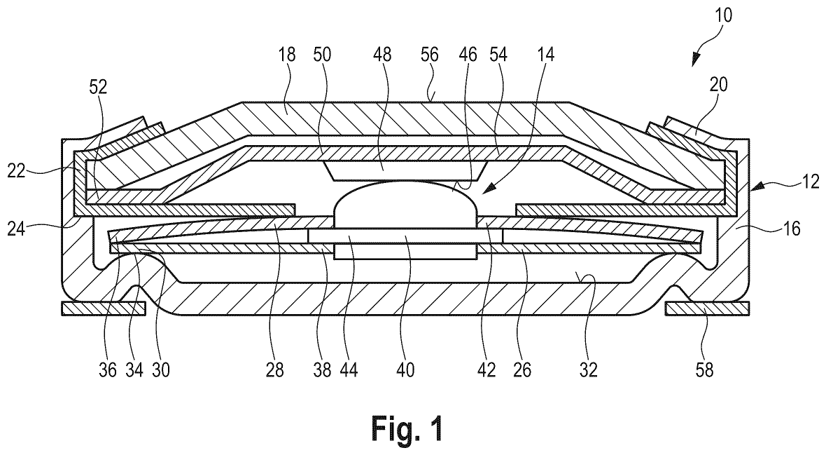

FIGS. 1-5 show four different embodiments of the switch, each in a schematic sectional view. In each case, the switch is denoted in its entirety by reference numeral 10.

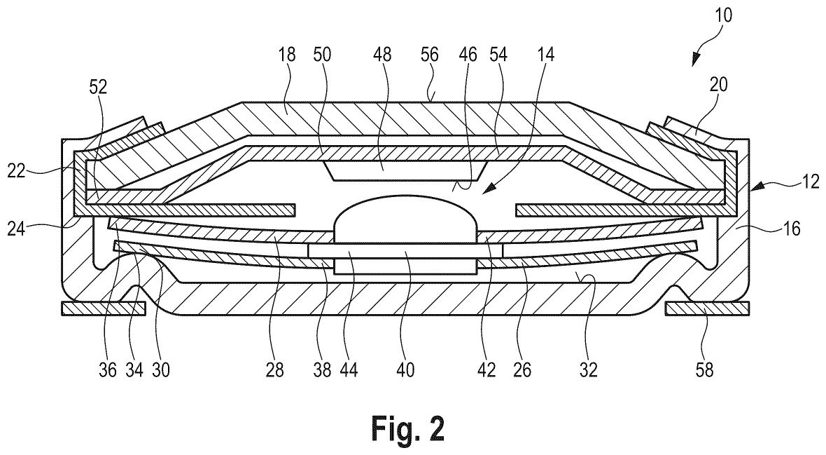

With regard to the switch according to the first embodiment, FIG. 1 shows the low-temperature state of the switch 10 and FIG. 2 shows the high-temperature state of the switch 10.

The switch 10 is configured to be rotationally symmetrical and has a circular shape when viewed from above. The switch 10 comprises a switch housing 12 in which a temperature-dependent switching mechanism 14 is arranged. The switch housing 12 comprises a pot-like lower part 16 and a cover part 18, which is held on the lower part 16 by a bent or flanged free upper edge 20.

The lower part 16 as well as the cover part 18 are made of an electrically conductive material, preferably metal. In the herein shown embodiment, the lower part 16 is a deep-drawn steel housing, which results in a comparatively high pressure resistance. An insulating foil 22 is arranged between the lower part 16 and the cover part 18, which serves to electrically insulate the two switch housing components 16, 18.

The upper edge 20 of the lower part 16 is bent radially inwards such that it presses the cover part 18 in the direction of a circumferential shoulder 24 provided in the lower part 16. The cover part 18 thus completely closes the lower part 16. In addition to the electrical insulation, the insulating foil 22 also provides a sufficient mechanical seal between the lower part 16 and the cover part 18, so that the interior of the switch housing 12 is sealed off from the outside. This prevents liquids or impurities from entering the interior of the housing from outside.

The switching mechanism 14 arranged inside the switch housing 12 comprises a temperature-independent spring element 26 and a temperature-dependent bimetal element 28. The spring element 26 is preferably designed as a circular disc-shaped spring disc. Particularly preferably, the spring element 26 is designed as a bistable spring disc comprising two temperature-independent stable geometric configurations. The first geometric configuration is shown in FIG. 1. The second geometric configuration is shown in FIG. 2.

The temperature-dependent bimetal element 28 is preferably designed as a bimetallic disc, which comprises two temperature-dependent configurations, a geometric low-temperature configuration (see FIG. 1) and a geometric high-temperature configuration (see FIG. 2).

In the low-temperature state of the switching mechanism 14 shown in FIG. 1, the spring element 26 rests with its edge 30 on a contact surface 34 projecting upwardly from the inner bottom surface 32 of the lower part. The inner bottom surface 32 is essentially concave in shape and, at the point at which the edge 30 of the spring element rests in the low-temperature state of the switching mechanism 14, is slightly raised relative to the central area of the inner bottom surface 32. The edge 36 of the bimetal element 28 rests on the spring element 26 in the low-temperature state of the switching mechanism 14 shown in FIG. 1.

The spring element 26 is fixed with its center 38 to a movable contact part 40 of the switching mechanism 14. The movable contact part 40 is preferably connected to the spring element 26 in a material-locking and/or positive locking manner. For example, the contact part 40 is welded or soldered to the spring element 26.

The bimetal element 28 can also be fixed with its center 42 to the movable contact part 40. However, the bimetal element 28 can also be loosely connected to the contact part 40 in that its centrally arranged opening is slipped over the contact part 40 and its center or the inner edge surrounding the opening rests from above on a support shoulder 44 provided on the contact part 40.

In the low-temperature state of the switching mechanism 14 shown in FIG. 1, the movable contact part 40 interacts with a contact surface 46 provided on the lower side of a contact part 48. In this low-temperature state of the switching mechanism 14, the spring element 26 presses the movable contact part 40 from below against the contact surface 46 of the contact part 48.

The contact part 48 is arranged at a contact carrier element 50, which in the embodiment shown in FIGS. 1 and 2 has a lid-like configuration. This lid-like contact carrier element 50 is also made of electrically conductive material and preferably comprises a thinner wall thickness than the cover part 18 of the switch housing 12 arranged above it.

In the area of its outer edge 52, the contact carrier element 50 rests on the shoulder 24 provided inside the lower part 16 with the insulating foil 22 interposed. With its top side, the contact carrier element 16 rests in the area of its outer edge 52 on the bottom side of the cover part 18. The outer edge 52 of the contact carrier element 50 is thus fixed in position by interaction of the lower part 16 and the top part 18, in that it is clamped between the lower part 16 and the cover part 18.

The central area 54 of the contact carrier element 50 is spaced from both the lower part 16 and the upper part 18 inside the switch housing 12. The central area 54 of the contact carrier element 50 thus has, depending on the elasticity of the contact carrier element 50, a limited movement within the switch housing 12.

In the first embodiment shown in FIGS. 1 and 2, the contact carrier element 50 forms a kind of lower cover, which is arranged between the cover part 18 and the switching mechanism 14. In the low-temperature state of the switch 10 (see FIG. 1), the movable contact part 40 of the switching mechanism 14 is supported on the contact carrier element 50. In this switching position of the switching mechanism 14, the contact carrier element 50 accordingly exerts a force on the movable contact part 40 which is opposite to the force exerted by the spring element 26 on the movable contact part 40.

Depending on the shape of the contact carrier element 50, the contact pressure between the movable contact part 40 and the contact surface 46 can be adjusted. If, for example, a contact carrier element is used which is more upwardly curved in its central area 54, the contact pressure can be reduced in comparison to a contact carrier element 50 which is comparatively flatter in its central area 54. This can also compensate for corresponding manufacturing tolerances of the switching mechanism components 26, 28, 40 and the housing components 16, 18.

In the low-temperature state shown in FIG. 1, the switching mechanism 14 establishes an electrically conductive connection between a first electrical terminal 56 and a second electrical terminal 58. In the present embodiment, the upper side of the cover part 18 serves as the first electrical terminal 56. In the present embodiment, a welded connection ring, which is soldered or welded to the lower part 16 of the switch housing 12, serves as the second electrical terminal 58. In the low-temperature state of the switch 10, an electric current can thus flow from the first terminal 56 through the cover part 18 into the contact carrier element 50 and from there via the contact part 48 into the contact part 40 and via the spring element 26 into the lower part 16 and thus ultimately to the second terminal 58 (or vice versa).

If, starting from the situation shown in FIG. 1, the temperature of the device to be monitored by the switch 10 and thus also the temperature of the switch 10 and the switching mechanism 14 used therein rises above a response temperature of the bimetal element 28, the bimetal element 28 snaps from its low-temperature configuration shown in FIG. 1 to its high-temperature configuration shown in FIG. 2. The upper side of the bimetal element 28 thereby snaps from a convex curvature to a concave curvature. The bimetal element 28 is then supported from below with its outer edge 36 on the contact carrier element 50, with the insulating foil 22 in between. At the same time, the bimetal element 28 presses the movable contact part 40 downwards with its center 42 and lifts it off the contact surface 46. During this switching movement, the bimetal element 28 exerts a force that acts against the force exerted on the contact part 40 by the spring element 26 in the low-temperature state. As a result, the spring element 26 also snaps from its first convex shape shown on the upper side in FIG. 1 into its concave shape on the upper side as shown in FIG. 2.

This interrupts the flow of current through switch 10. The switch 10 is thus open.

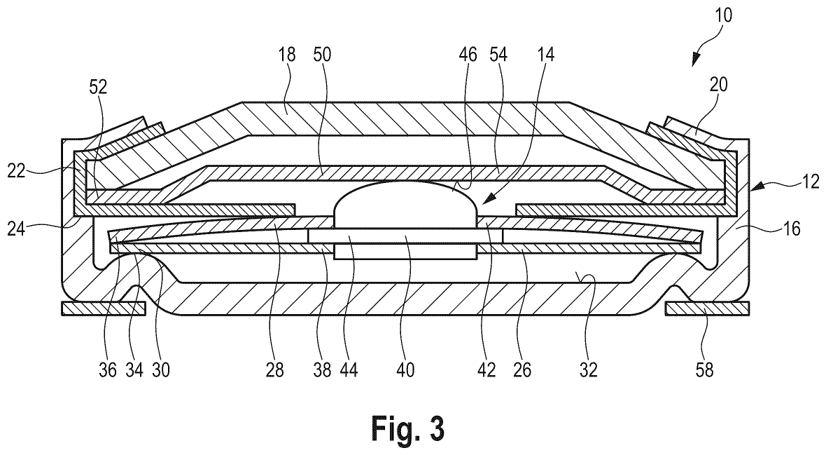

FIG. 3 shows a further embodiment of the switch 10. The second embodiment shown in FIG. 3 differs from the first embodiment shown in FIGS. 1 and 2 in particular in that the contact surface 46 is arranged directly on the contact carrier element 50, i.e. no extra contact part 48 is attached to the contact carrier element 50. The contact carrier element 50 is accordingly somewhat flatter here than in the first embodiment. In particular, the central area 54 of the contact carrier element 50 is thus comparatively further away from the bottom side of the cover part 18.

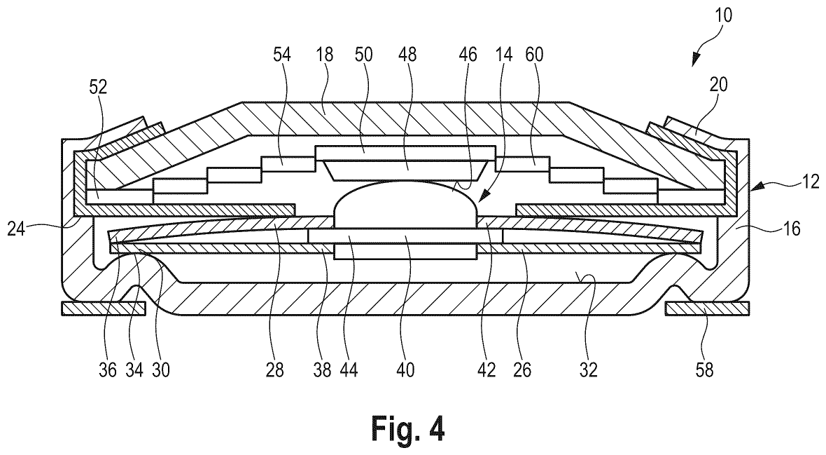

FIG. 4 shows a third embodiment of the switch 10, in which the contact carrier element 50 comprises a spring element 60. This spring element 60 is preferably arranged in the central area 54 of the contact carrier element 50, wherein the contact part 58, on which the contact surface 46 is provided, is arranged at the spring element 60. In principle, however, it is also possible for the contact carrier element 50 to be configured in its entirety as a spring element 60.

In the following, the spring element 60 is referred to as the “second spring element” for better differentiation from the spring element 26. The spring element 26 is referred to as the “first spring element” in the following.

The contact carrier element 50 is designed as a kind of counter-spring, which counteracts the spring element 26 in the low-temperature state of the switching mechanism 14. This allows the contact force with which the movable contact part 40 is pressed against the contact surface 46 in the low-temperature state of the switching mechanism 14 to be increased. This has the advantage that the contact resistance can be reduced and thus the performance of the switch 10 can be increased. Furthermore, the second spring element 60 enables further tolerance compensation.

The spring force exerted by the first spring element 26 is opposite to the spring force exerted by the second spring element 60. Preferably, the spring force exerted by the second spring element 60 on the movable contact part 40 via the contact part 48 is larger in amount than the spring force exerted by the first spring element 26 on the contact part 40. However, the second spring element 60 preferably has a smaller spring travel than the first spring element 26.

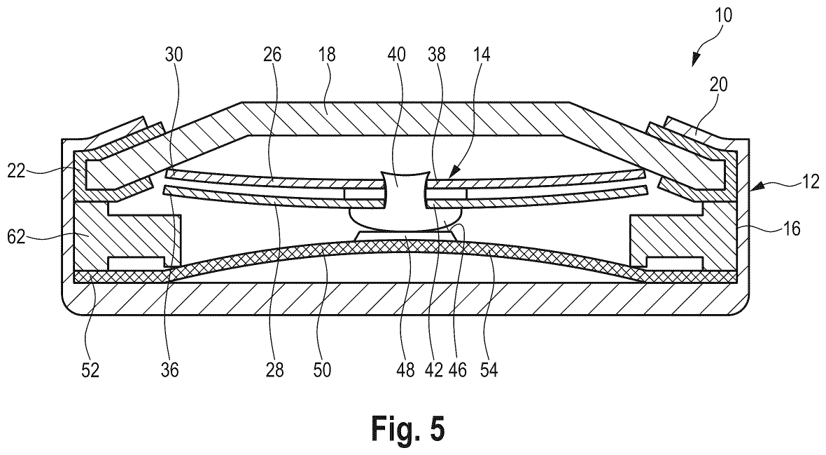

FIG. 5 shows a fourth embodiment of the switch 10, in which the contact carrier element 50 is arranged below the switching mechanism 14, i.e. between the switching mechanism 14 and the lower part 16. The contact carrier element 50 is inserted into the lower part 16 and is clamped with its outer edge 52 between the lower part 16 and a spacer ring 62 acting as a hold-down. The spacer ring 62 can be made of an electrically conductive material or an electrically insulating material. The cover part 18 rests from above on this spacer ring 62 with the insulating foil 22 interposed. Thus, also according to this embodiment, the contact carrier element 50 is indirectly clamped between the lower part 16 and the cover part 18 and is fixed in its position by the interaction of the lower part 16 and the cover part 18.

Compared to the embodiments shown in FIGS. 1-4, the switching mechanism 14 is turned upside down by 180°. In the low-temperature state of the switch 10, the first spring element 26 is supported with its outer edge 30 on the lower side of the cover part 18 and presses the contact part 40 upwardly against the contact surface 46 provided on the contact carrier element 50. In this switching state, the outer edge 36 of the bimetal element 28 hangs freely below it.

In the high temperature state of the switch 10 shown in FIG. 5 (high temperature state not shown separately), however, the bimetal element 28 is supported with its outer edge 36 on the spacer ring 62 and thereby lift off the movable contact part 40 from the contact surface 46, so that the switch 10 is open.

In the fourth embodiment, the contact part 40 is formed in two parts. Both the spring element 26 and the bimetal element 28 are held captive with their respective centers 38, 42 on the contact part 40, which is configured as a rivet.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A temperature-dependent switch, comprising:
a switch housing having a lower part and a cover part closing the lower part;
a contact carrier element arranged in the switch housing and comprising a contact surface, wherein at least one section of the contact carrier element is fixed in position by an interaction of the lower part and the cover part; and
a temperature-dependent switching mechanism, which is arranged in the switch housing and comprises a movable contact part which interacts with the contact surface arranged at the contact carrier element, wherein the switching mechanism is configured to switch in a temperature-dependent manner between a low-temperature state and a high-temperature state,
wherein, in the low-temperature state, the switching mechanism presses the movable contact part in contact with the contact surface in order to establish an electrical connection between a first electrical terminal of the switch and a second electrical terminal of the switch, and wherein, in the high-temperature state, the switching mechanism keeps the movable contact part spaced apart from the contact surface in order to interrupt the electrical connection between the first electrical terminal and the second electrical terminal.

2. The temperature-dependent switch according to claim 1, wherein the switching mechanism is arranged between the contact carrier element and the lower part, and wherein the contact carrier element is connected to the cover part in an electrically conductive manner.

3. The temperature-dependent switch according to claim 1, wherein the switching mechanism is arranged between the contact carrier element and the cover part, and wherein the contact carrier element is connected to the lower part in an electrically conductive manner.

4. The temperature-dependent switch according to claim 1, wherein the at least one section of the contact carrier element comprises an outer edge of the contact carrier element, and wherein a central area of the contact carrier element is spaced from both the lower part and the cover part.

5. The temperature-dependent switch according to claim 1, wherein the contact carrier element is clamped directly or indirectly between the lower part and the cover part.

6. The temperature-dependent switch according to claim 1, wherein the contact carrier element is configured in a lid-like manner and has a thinner wall thickness than the cover part.

7. The temperature-dependent switch according to claim 1, wherein the switching mechanism comprises a first spring element which, in the low-temperature state of the switching mechanism, exerts a first spring force by which the movable contact part is pressed against the contact surface.

8. The temperature-dependent switch according to claim 7, wherein the contact carrier element comprises a second spring element which, in the low-temperature state of the switching mechanism, exerts a second spring force by which the contact surface is pressed against the movable contact part.

9. The temperature-dependent switch according to claim 8, wherein the first spring force is opposite to the second spring force.

10. The temperature-dependent switch according to claim 9, wherein the second spring force is larger than the first spring force.

11. The temperature-dependent switch according to claim 8, wherein the first spring element has a larger travel than the second spring element.

12. The temperature-dependent switch according to claim 8, wherein the switching mechanism comprises a bimetal element, and wherein the bimetal element exerts an opening force on the movable contact part in the high-temperature state of the switching mechanism, which opening force is opposite to the first spring force and larger than the first spring force.

13. The temperature-dependent switch according to claim 1, wherein the first electrical terminal is arranged at the cover part and the second electrical terminal is arranged at the lower part.

14. The temperature-dependent switch according to claim 1, further comprising an insulating foil arranged between the lower part and the contact carrier element.

15. The temperature-dependent switch according to claim 1, wherein the lower part comprises a free upper edge that is flanged or bent onto the cover part.
